(19) United States
(12) Patent Application Publication
(10) Pub. No.: US 2024/0141766 A1
(43) Pub. Date: May 2, 2024

(54) BIDIRECTIONAL SELF-REGULATING CHEMICAL FLOODING METHOD AND SYSTEM FOR ENHANCING OIL RECOVERY

(71) Applicants: China University of Petroleum (East China), Qingdao (CN); Shandong University of Science And Technology, Qingdao (CN)

(72) Inventors: Jian Hou, Qingdao (CN); Kang Zhou, Qingdao (CN); Zhinbin An, Qingdao (CN); Qingjun Du, Qingdao (CN); Yongge Liu, Qingdao (CN); Bei Wei, Qingdao (CN); Dejun Wu, Qingdao (CN); Shuai Liu, Qingdao (CN)

(21) Appl. No.: 18/057,685

(22) Filed: Nov. 21, 2022

(30) Foreign Application Priority Data
Oct. 26, 2022 (CN) 202211318431.3

(51) Int. Cl. E21B 43/16

(52) U.S. Cl. CPC E21B 43/16; E21B 2200/20

(57) ABSTRACT

A bidirectional self-regulating chemical flooding method and system for enhancing oil recovery includes: determining the average particle size of dispersed phase droplets under stable seepage flow of an oil-in-water emulsion according to the average reservoir permeability; determining injection concentration of an emulsifier which matches a target reservoir according to reservoir seepage velocity; under a condition of keeping the injection concentration of the emulsifier constant, determining the optimal injection concentration of a polymer which matches the injection concentration of the emulsifier through core flooding experiments with the maximum equivalent ton oil accumulation as a target; determining total injection amount of the emulsifier and total injection amount of the polymer for implementing well group units; and optimizing injection amount of the emulsifier and the polymer in each single well by using a numerical simulator of a chemical flooding reservoir.

### CROSS REFERENCES

This application claims priority to Chinese Patent Application Ser. No. CN202211318431.3 filed on 26 Oct. 2022.

### FIELD OF THE INVENTION

The present disclosure relates to a bidirectional self-regulating chemical flooding method and system for enhancing oil recovery, belonging to the technical field of oil and gas field development.

### BACKGROUND OF THE INVENTION

China is rich in high-viscosity reservoirs, with about 1.3 billion tons of geological reserves. At present, such reservoirs are mainly developed by water flooding and steam stimulation. However, due to high viscosity of crude oil and a water-oil viscosity ratio of less than 0.005, there exist such problems as serious viscosity fingering, low sweep efficiency of less than 55%, and low recovery of less than 20%. Chemical flooding technologies such as polymer flooding can improve recovery of common heavy oil reservoirs to some extent by increasing viscosity of water phase and reducing a water-oil viscosity ratio. However, due to a limited increase range of viscosity of water phase and synchronous increase of seepage resistance, existing chemical flooding technologies at home and abroad are only applicable to reservoirs with underground crude oil viscosity of less than 100 mPa·s, failing to effectively exploit high-viscosity reservoirs with underground crude oil viscosity of 100 mPa·s to 2000 mPa·s. Thermal oil recovery methods such as steam stimulation can reduce viscosity of oil phase and improve a water-oil mobility ratio by injecting high temperature fluid to heat the stratum, which can improve recovery of high-viscosity reservoirs. But there are also several problems in steam heating, including a large amount consumption of energy, high economic costs, a large amount emission of carbon dioxide, and high environmental pressure. Therefore, it is urgent to create a new type of chemical composite flooding method with cold production for high-viscosity reservoirs to greatly improve oil recovery.

Field practice shows that injection of an emulsifier into a reservoir is capable of emulsifying heavy oil with high viscosity into an oil-in-water emulsion with low viscosity, playing roles in reducing viscosity of oil phase and promoting the flow. And a polymer solution is capable of effectively increasing viscosity of water phase to inhibit water breakthrough and expand the affecting range.

### SUMMARY OF THE INVENTION

In view of deficiencies of the prior art, the present disclosure provides a bidirectional self-regulating chemical flooding method for enhancing oil recovery. The present disclosure provides a novel chemical flooding method for bidirectionally adjusting a water-oil viscosity ratio by synergistic effects of an emulsifier on reducing viscosity of oil phase and a polymer on increasing viscosity of water phase. And a method for determining particle size of dispersed phase droplets of an emulsion, injection concentration of an emulsifier and a polymer, and injection amount of chemical agents in a well group unit, which match the target reservoir, is also provided, helping implement the bidirectional self-regulating chemical flooding method in the field to improve a flow rate ratio of oil to water and to improve oil recovery in high-viscosity reservoirs, and providing an important support for China's energy security.

The present disclosure also provides a bidirectional self-regulating chemical flooding system for enhancing oil recovery.

### Explanation of Terms

Core flooding experiments refer to simulate actual exploitation of underground crude oil under laboratory conditions, in which a displacement fluid such as a chemical agent solution is injected into an inlet end of a natural core stored in a holder via an injection pump, and crude oil which has been saturated in the core in advance is displaced from an outlet end, and real-time data such as injection pressure, oil production and water production during a flooding process are recorded via a pressure monitoring and fluid collecting device. Main experimental procedures include core vacuum saturated water, permeability tests, saturated crude oil, early water flooding, chemical injection and subsequent water flooding.

Technical solutions of the present disclosure are:

A bidirectional self-regulating chemical flooding method for enhancing oil recovery includes the following steps:
(1) calculating the average particle size of dispersed phase droplets under stable seepage flow of an oil-in-water emulsion;
according to the average reservoir permeability, calculating the average particle size of dispersed phase droplets of an emulsion which matches a target reservoir, based on a matching relationship model between the average particle size of dispersed phase droplets of the oil-in-water emulsion and the average reservoir permeability under stable seepage flow of the oil-in-water emulsion;
(2) calculating injection concentration of an emulsifier;
according to the average particle size of the dispersed phase droplets under stable seepage flow of the oil-in-water emulsion calculated in step (1) and reservoir seepage velocity determined by field implementation conditions, calculating injection concentration of the emulsifier which matches the target reservoir, based on a regression relationship model among the average particle size of the dispersed phase droplets, the reservoir seepage velocity and the injection concentration of the emulsifier;
(3) calculating injection concentration of a polymer;
under a condition of keeping the injection concentration of the emulsifier constant, adjusting injection concentration of the polymer, carrying out several groups of core flooding experiments, counting injection volume and cumulative oil production of emulsifier solution and polymer solution in each group of the core flooding experiments, and calculating equivalent ton oil accumulation, where injection concentration of the polymer used in the core flooding experiments with the maximum equivalent ton oil accumulation is the optimal injection concentration of the polymer which matches the injection concentration of the emulsifier;
(4) calculating total injection amount of the emulsifier and the polymer in well group units;
according to pore volume of well group units and a given injection pore volume multiple, calculating total injection amount of the emulsifier and total injection amount of the polymer required by the well group units, based on the injection concentration of the emulsifier calculated in step (2) and the injection concentration of the polymer calculated in step (3); and
(5) optimizing injection amount of the emulsifier and the polymer in each single well;
performing simulated calculation on different combination schemes of adjustable variables by using a numerical simulator for a chemical flooding reservoir, and counting cumulative recovery degree of each scheme, with the maximum cumulative recovery degree as a target, and the total injection amount of the emulsifier and the polymer in the well group units determined in step (4) as a constraint condition, and injection amount of the emulsifier and the polymer in each single well as an adjustable variable, where an adjustable variable corresponding to the maximum value of schemes is the optimal value of injection amount of the emulsifier and the polymer in each single well.

Preferably, a calculating formula (I) for the average particle size of dispersed phase droplets of the emulsion which matches the target reservoir in step (1) according to the present disclosure is shown as follows:

d=exp((k−0.1583)/2.3194) (I)

Where k represents the average reservoir permeability, m²; d represents the average particle size of dispersed phase droplets of the emulsion which matches the target reservoir, μm; and exp) represents an exponential function.

Preferably, a calculating formula (II) for the injection concentration of the emulsifier which matches the target reservoir in step (2) according to the present disclosure is shown as follows:

wₘ=4.15 exp(0.06d+6.63v²−4.58v) (II)

Where wₘ represents the injection concentration of the emulsifier which matches the target reservoir, kg/m³; d represents the average particle size of dispersed phase droplets of the emulsion which matches the target reservoir, μm; v represents the reservoir seepage velocity, cm/min; and exp( ) represents an exponential function.

Preferably, a calculating formula (III) for the equivalent ton oil accumulation in step (3) according to the present disclosure is shown as follows:

$${E}_{t} = \frac{{Q}_{o} - {Q}_{oi}}{{w}_{p} {V}_{p} + {w}_{m} {V}_{m} {P}_{m} / {P}_{p}} \qquad ( III )$$

Where Eₜ represents the equivalent ton oil accumulation, m³/t; Qₒ represents the cumulative oil production by chemical flooding, 10⁻⁶ m³; Qₒᵢ represents the cumulative oil production by water flooding, 10⁻⁶ m³; wₚ represents the injection concentration of the polymer, kg/m³; Vₚ represents the injection volume of the polymer solution, 10⁻⁶ m³; wₘ represents the injection concentration of the emulsifier, kg/m³; Vₘ represents the injection volume of the emulsifier solution, 10⁻⁶ m³; Pₚ represents the price of polymer dry powder, yuan/t; and Pₘ represents the price of emulsifier dry powder, yuan/t.

Preferably, a calculating formula (IV) for the total injection amount of the emulsifier required by the well group units in step (4) according to the present disclosure is shown as follows:

mₘ=αV_{φ}wₘ (IV)

Where mₘ represents the total injection amount of the emulsifier, kg; α represents the injection pore volume multiple of bidirectional self-regulating chemical flooding, PV; V_{φ} represents the pore volume of the well group units, m³; and wₘ represents the injection concentration of the emulsifier calculated in step (2), kg/m³.

Preferably, a calculating formula (V) for the total injection amount of the polymer required by the well group units in step (4) according to the present disclosure is shown as follows:

mₚ=αV_{φ}wₚ (V)

Where m represents the total injection amount of the polymer, kg; and represents the injection concentration of the polymer calculated in step (3), kg/m³.

A bidirectional self-regulating chemical flooding system for enhancing oil recovery includes:
a module for calculating the average particle size of dispersed phase droplets of an emulsion, configured to calculate the average particle size of the dispersed phase droplets under stable seepage flow of an oil-in-water emulsion;
a module for calculating injection concentration of an emulsifier, configured to calculate injection concentration of an emulsifier;
a module for calculating injection concentration of a polymer, configured to calculate injection concentration of a polymer;
a module for calculating total injection amount of the emulsifier and the polymer in well group units, configured to calculate total injection amount of the emulsifier and the polymer in well group units; and
a module for optimizing injection amount of the emulsifier and the polymer in each single well, configured to optimize injection amount of the emulsifier and the polymer in each single well.

Beneficial effects of the present disclosure are:
1. The viscosity reduction effect of heavy oil emulsion can be ensured, and at the same time, destructive blockage of pore throat structure by dispersed phase droplets due to Jamin effect can be avoided by calculating the average particle size of dispersed phase droplets of an oil-in-water emulsion which matches a target reservoir, effectively enhancing oil recovery.
2. The bidirectional synergistic effects of the emulsifier on reducing viscosity of oil phase and the polymer on increasing viscosity of water phase can be exerted to the maximum extent by calculating injection concentration of the emulsifier and injection concentration of the polymer which matches thereof required by the target particle size of dispersed phase droplets sequentially, greatly reducing the oil-water viscosity ratio, and enhancing oil recovery.
3. The utilization rate of chemical agents can be improved as much as possible without increasing the total injection amount, and the development effect of the reservoir economic technology can be maximized by calculating the total injection amount of the emulsifier and the polymer in well group units and using it as a constraint condition to optimize different injection amount of the emulsifier and the polymer in each well group.

### BRIEF DESCRIPTION OF THE DRAWINGS

FIG. 1 is a schematic diagram of the correlation between equivalent ton oil accumulation and injection concentration of a polymer;

FIG. 2 is a schematic diagram of well location distributions of well group units; and

FIG. 3 is a graph of oil recovery variation.

### DETAILED DESCRIPTION OF THE EMBODIMENTS

The present disclosure is further defined below, but not limited to, in conjunction with the accompanying drawings and embodiments.

### Embodiment 1

A bidirectional self-regulating chemical flooding method for enhancing oil recovery includes the following steps:

(1) Calculating the Average Particle Size of Dispersed Phase Droplets Under Stable Seepage Flow of an Oil-In-Water Emulsion

According to the average reservoir permeability obtained from a mine coring test where the average permeability of a well group unit in a certain reservoir in China is 1.85 μm², the average particle size of dispersed phase droplets of an emulsion which matched a target reservoir was calculated based on a matching relationship model between the average particle size of dispersed phase droplets of an oil-in-water emulsion and the average reservoir permeability under stable seepage flow of the oil-in-water emulsion.

A calculating formula (I) for the average particle size of dispersed phase droplets of the emulsion which matched the target reservoir was shown as follows:

d=exp((k−0.1583)/2.3194) (I)

In formula (I), k represented the average reservoir permeability, μm²; d represented the average particle size of dispersed phase droplets of the emulsion which matched the target reservoir, μm; and exp(represented an exponential function.

The average particle size of dispersed phase droplets of an emulsion matching the permeability of the well group unit was calculated to be 2.08 μm according to formula (I).

(2) Calculating Injection Concentration of an Emulsifier

According to the average particle size of the dispersed phase droplets under stable seepage flow of the oil-in-water emulsion calculated in step (1) and the average reservoir seepage velocity interpreted from field tracer tests, injection concentration of an emulsifier which matches the target reservoir was calculated based on a regression relationship model among the average particle size of the dispersed phase droplets, the reservoir seepage velocity and the injection concentration of the emulsifier.

A calculating formula (II) for the injection concentration of the emulsifier which matched the target reservoir was shown as follows:

wₘ=4.15 exp(0.06d+6.63v²−4.58v) (II)

In formula (II), wₘ, represented the injection concentration of the emulsifier which matched the target reservoir, kg/m³; d represented the average particle size of dispersed phase droplets of the emulsion which matched the target reservoir, μm; v represented the reservoir seepage velocity, cm/min; and exp( ) represented an exponential function.

In this example, the seepage velocity was 0.1 cm/min, and the injection concentration of the emulsifier was calculated to be 3.18 kg/m³ according to formula (II).

Injection concentration of a polymer was adjusted to carry out several groups of core flooding experiments, injection volume and cumulative oil production of emulsifier and polymer solutions in each group of the core flooding experiments were counted, and equivalent ton oil accumulation was calculated, where injection concentration of the polymer used in the core flooding experiments with the maximum equivalent ton oil accumulation was the optimal injection concentration of the polymer which matched the injection concentration of the emulsifier.

(3) Calculating Injection Concentration of a Polymer

Under a condition of keeping the injection concentration of the emulsifier constant at 3.18 kg/m³, five groups of flooding experiments of emulsifier and polymer solutions were carried out by using a core model, where the injection concentration of the polymer was 0.5 kg/m³, 1.0 kg/m³, 1.5 kg/m³, 2.0 kg/m³ and 2.5 kg/m³, respectively. The cumulative oil production in each group of core flooding experiments was counted, the equivalent ton oil accumulation was calculated, and relationship curves between equivalent ton oil accumulation and injection concentration of a polymer was drawn and nonlinear relationship models thereof were regressed. Injection concentration of the polymer with the maximum equivalent ton oil accumulation calculated by optimization was the optimal injection concentration of the polymer which matched the injection concentration of the emulsifier.

A calculating formula (III) for the equivalent ton oil accumulation was shown as follows:

$${E}_{t} = \frac{{Q}_{o} - {Q}_{oi}}{{w}_{p} {V}_{p} + {w}_{m} {V}_{m} {P}_{m} / {P}_{p}} \qquad ( III )$$

In formula (III), Eₜ represented the equivalent ton oil accumulation, m³/t; Qₒ represented the cumulative oil production by chemical flooding, 10⁻⁶ m³; Qₒᵢ represented the cumulative oil production by water flooding, 10⁻⁶ m³; wₚ represented the injection concentration of the polymer, kg/m³; Vₚ represented the injection volume of the polymer solution, 10⁻⁶ m³; wₘ represented the injection concentration of the emulsifier, kg/m³; Vₘ represented the injection volume of the emulsifier solution, 10⁻⁶ m³; P represented the price of polymer dry powder, yuan/t; and Pₘ represented the price of emulsifier dry powder, yuan/t.

In the core flooding experiments of this embodiment, the injection volume of the emulsifier solution was 185×10⁻⁶ m³, the injection volume of the polymer solution was 185×10⁻⁶ m³, the price of the emulsifier dry powder was 20000 yuan/t, the price of the polymer dry powder was 15000 yuan/t. And results of oil production and equivalent ton oil accumulation in five groups of core flooding experiments were shown in Table 1:

TABLE 1

| | | Oil | Cumulative | Oil | |
|---|---|---|---|---|---|
| | Injection | production | oil production | accumulation | Equivalent |
| Experiment | concentration | by water | by chemical | by chemical | ton oil |
| serial | of a polymer, | flooding, | flooding, | flooding, | accumulation, |
| number | kg/m³ | 10⁻⁶ m³ | 10⁻⁶ m³ | 10⁻⁶ m³ | m³/t |
| 1 | 0.5 | 32.1 | 50.4 | 18.3 | 37.76 |
| 2 | 1.0 | 31.8 | 56.2 | 24.4 | 42.27 |
| 3 | 1.5 | 32.4 | 63.5 | 31.1 | 46.44 |
| 4 | 2.0 | 32.7 | 66.8 | 34.1 | 44.74 |
| 5 | 2.5 | 32.0 | 68.2 | 36.2 | 42.35 |

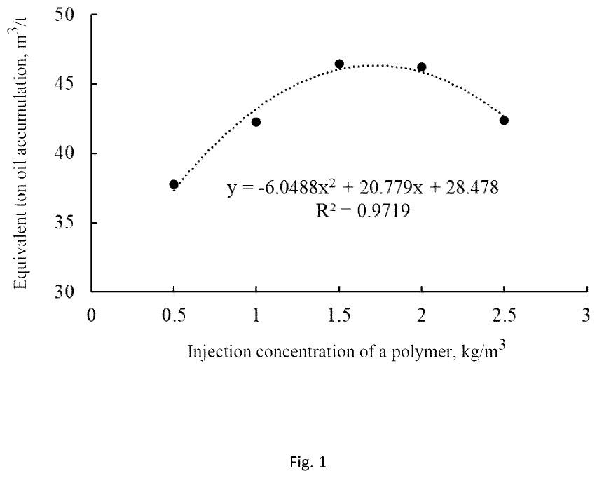

The correlation between the equivalent ton oil accumulation and the injection concentration of the polymer was shown in FIG. 1. The optimal injection concentration of the polymer was calculated to be 1.71 kg/m³ by optimization.

(4) Calculating Total Injection Amount of the Emulsifier and the Polymer in Well Group Units

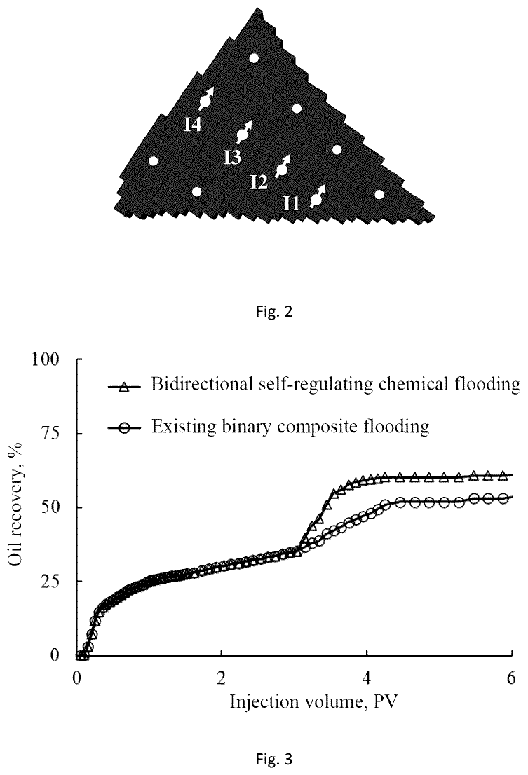

Well location distributions of the well group units were shown in FIG. 2. According to pore volume of well group units calculated by field tests and an injection pore volume multiple given by implementing bidirectional self-regulating chemical flooding in the field, total injection amount of the emulsifier and total injection amount of the polymer required by the well group units were calculated based on the injection concentration of the emulsifier calculated in step (2) and the injection concentration of the polymer calculated in step (3).

A calculating formula (V) for the total injection amount of the polymer required by the well group units was shown as follows:

mₚ=αV_{φ}wₚ (V)

In formula (V), mₚ represented the total injection amount of the polymer, kg; and wₚ represented the injection concentration of the polymer calculated in step (3), kg/m³.

A calculating formula (IV) for the total injection amount of the emulsifier required by the well group units was shown as follows:

mₘ=αV_{φ}wₘ (IV)

In formula (IV), mₘ represented the total injection amount of the emulsifier, kg; α represented the injection pore volume multiple of bidirectional self-regulating chemical flooding, PV; V_{φ} represented the pore volume of the well group units, m³; and wₘ represented the injection concentration of the emulsifier calculated in step (2), kg/m³.

In this example, the injection pore volume multiple of bidirectional self-regulating chemical flooding was 0.4 PV, the pore volume of the well group units was 1.22×10⁶ m³, the injection concentration of the emulsifier determined in step (3) was 3.18 kg/m³, and the injection concentration of the polymer determined in step (4) was 1.71 kg/m³. According to the above formula, the total injection amount of the emulsifier and the total injection amount of the polymer required for implementing bidirectional self-regulating chemical flooding in the well group units were calculated to be 1546 t and 831 t, respectively.

(5) Optimizing Injection Amount of the Emulsifier and the Polymer in Each Single Well

Simulated calculation on different combination schemes of adjustable variables was performed by using a numerical simulator for a chemical flooding reservoir, and cumulative recovery degree of each scheme was counted, with the maximum cumulative recovery degree as a target, and the total injection amount of the emulsifier and the polymer in the well group units determined in step (4) as a constraint condition, and injection amount of the emulsifier and the polymer in each single well as an adjustable variable, where an adjustable variable corresponding to the maximum value of schemes was the optimal value of injection amount of the emulsifier and the polymer in each single well. The optimized injection amount of the emulsifier and the polymer in each single well was shown in Table 2.

TABLE 2

| | | | Total |
|---|---|---|---|
| | | | injection |
| | Injection | Injection | amount of |
| Injection | amount of a | amount of an | chemical |
| well name | polymer, t | emulsifier, t | agents, t |
| I1 | 198.4 | 369.1 | 567.5 |
| I2 | 210.5 | 391.7 | 602.2 |
| I3 | 206.3 | 383.8 | 590.1 |
| I4 | 215.8 | 401.4 | 617.2 |
| Total | 831 | 1546 | 2377 |

Based on well group models of this example, numerical simulation calculation of new bidirectional self-regulating chemical flooding and existing binary composite flooding with polymer/surfactant were carried out, where injection parameters of the emulsifier and the polymer used in the bidirectional self-regulating chemical flooding were described in steps (2) to (5), and where the injection parameters of the polymer in the binary composite flooding were consistent with the injection parameters of the polymer in the bidirectional self-regulating chemical flooding, and the injection parameters of the surfactant were consistent with the injection parameters of the emulsifier in the bidirectional self-regulating chemical flooding. Correlation curves of oil recovery calculated by the two chemical flooding methods were shown in FIG. 3. It can be seen that oil recovery can be improved by 7.2% using the bidirectional self-regulating chemical flooding method provided in the present disclosure.

### Embodiment 2

A bidirectional self-regulating chemical flooding system for enhancing oil recovery includes:
a module for calculating the average particle size of dispersed phase droplets of an emulsion, configured to calculate the average particle size of the dispersed phase droplets under stable seepage flow of an oil-in-water emulsion;
a module for calculating injection concentration of an emulsifier, configured to calculate injection concentration of an emulsifier;
a module for calculating injection concentration of a polymer, configured to calculate injection concentration of a polymer;
a module for calculating total injection amount of the emulsifier and the polymer in well group units, configured to calculate total injection amount of the emulsifier and the polymer in well group units; and
a module for optimizing injection amount of the emulsifier and the polymer in each single well, configured to optimize injection amount of the emulsifier and the polymer in each single well.

What is claimed is:

1. A bidirectional self-regulating chemical flooding method for enhancing oil recovery, comprising the following steps:
(i) calculating the average particle size of dispersed phase droplets under stable seepage flow of an oil-in-water emulsion;
according to the average reservoir permeability, calculating the average particle size of dispersed phase droplets of an emulsion which matches a target reservoir, based on a matching relationship model between the average particle size of dispersed phase droplets of the oil-in-water emulsion and the average reservoir permeability under stable seepage flow of the oil-in-water emulsion;
(ii) calculating injection concentration of an emulsifier;
according to the average particle size of the dispersed phase droplets under stable seepage flow of the oil-in-water emulsion calculated in step (i) and reservoir seepage velocity determined by field implementation conditions, calculating injection concentration of the emulsifier which matches the target reservoir, based on a regression relationship model among the average particle size of the dispersed phase droplets, the reservoir seepage velocity and the injection concentration of the emulsifier;
(iii) calculating injection concentration of a polymer;
under a condition of keeping the injection concentration of the emulsifier constant, adjusting injection concentration of the polymer, carrying out several groups of core flooding experiments, counting injection volume and cumulative oil production of emulsifier solution and polymer solution in each group of the core flooding experiments, and calculating equivalent ton oil accumulation, wherein injection concentration of the polymer used in the core flooding experiments with the maximum equivalent ton oil accumulation is the optimal injection concentration of the polymer which matches the injection concentration of the emulsifier;
(iv) calculating total injection amount of the emulsifier and the polymer in well group units;
according to pore volume of well group units and a given injection pore volume multiple, calculating total injection amount of the emulsifier and total injection amount of the polymer required by the well group units, based on the injection concentration of the emulsifier calculated in step (ii) and the injection concentration of the polymer calculated in step (3); and
(v) optimizing injection amount of the emulsifier and the polymer in each single well;
performing simulated calculation on different combination schemes of adjustable variables by using a numerical simulator for a chemical flooding reservoir, and counting cumulative recovery degree of each scheme, with the maximum cumulative recovery degree as a target and the total injection amount of the emulsifier and the polymer in the well group units determined in step (iv) as a constraint condition, and injection amount of the emulsifier and the polymer in each single well as an adjustable variable, wherein an adjustable variable corresponding to the maximum value of schemes is the optimal value of injection amount of the emulsifier and the polymer in each single well.

2. The bidirectional self-regulating chemical flooding method for enhancing oil recovery according to claim 1, wherein a calculating formula (I) for the average particle size of dispersed phase droplets of the emulsion which matches the target reservoir in step (1) is shown as follows:
d=exp((k−0.1583)/2.3194) (I)
wherein k represents the average reservoir permeability, μm²; d represents the average particle size of dispersed phase droplets of the emulsion which matches the target reservoir, μm;
and exp( ) represents an exponential function.

3. The bidirectional self-regulating chemical flooding method for enhancing oil recovery according to claim 1, wherein a calculating formula (II) for the injection concentration of the emulsifier which matches the target reservoir in step (ii) is shown as follows:
wₘ=4.15 exp(0.06d+6.63v²−4.58v) (II)
wherein wₘ represents the injection concentration of the emulsifier which matches the target reservoir, kg/m³; d represents the average particle size of dispersed phase droplets of the emulsion which matches the target reservoir, μm; v represents the reservoir seepage velocity, cm/min; and exp( ) represents an exponential function.

4. The bidirectional self-regulating chemical flooding method for enhancing oil recovery according to claim 1, wherein a calculating formula (III) for the equivalent ton oil accumulation in step (iii) is shown as follows:
$${E}_{t} = \frac{{Q}_{o} - {Q}_{oi}}{{w}_{p} {V}_{p} + {w}_{m} {V}_{m} {P}_{m} / {P}_{p}} \qquad ( III )$$
wherein Eₜ represents the equivalent ton oil accumulation, m³/t; Q₀ represents the cumulative oil production by chemical flooding, 10⁻⁶ m³; Q^{of} represents the cumulative oil production by water flooding, 10⁻⁶ m³; wₚ represents the injection concentration of the polymer, kg/m³; Vₚ represents the injection volume of the polymer solution, 10⁻⁶ m³; wₘ represents the injection concentration of the emulsifier, kg/m³; Vₘ represents the injection volume of the emulsifier solution, 10⁻⁶ m³; P represents the price of polymer dry powder, yuan/t; and Pₘ represents the price of emulsifier dry powder, yuan/t.

5. The bidirectional self-regulating chemical flooding method for enhancing oil recovery according to claim 1, wherein a calculating formula (IV) for the total injection amount of the emulsifier required by the well group units in step (iv) is shown as follows:
mₘ=αV_{φ}wₘ (IV)
wherein mₘ represents the total injection amount of the emulsifier, kg; α represents the injection pore volume multiple of bidirectional self-regulating chemical flooding, PV; V_{φ} represents the pore volume of the well group units, m³; and wₘ represents the injection concentration of the emulsifier calculated in step (ii), kg/m³.

6. The bidirectional self-regulating chemical flooding method for enhancing oil recovery according to claim 1, wherein a calculating formula (V) for the total injection amount of the polymer required by the well group units in step (iv) is shown as follows:
mₚ=αV_{φ}wₚ (V)
wherein mₚ represents the total injection amount of the polymer, kg; and wₚ represents the injection concentration of the polymer calculated in step (iii), kg/m³.

7. A bidirectional self-regulating chemical flooding system for enhancing oil recovery, comprising:
a module for calculating the average particle size of dispersed phase droplets of an emulsion, configured to calculate the average particle size of the dispersed phase droplets under stable seepage flow of an oil-in-water emulsion;
a module for calculating injection concentration of an emulsifier, configured to calculate injection concentration of an emulsifier;
a module for calculating injection concentration of a polymer, configured to calculate injection concentration of a polymer;
a module for calculating total injection amount of the emulsifier and the polymer in well group units, configured to calculate total injection amount of the emulsifier and the polymer in well group units; and
a module for optimizing injection amount of the emulsifier and the polymer in each single well, configured to optimize injection amount of the emulsifier and the polymer in each single well.
